(19) United States
(12) Patent Application Publication
(10) Pub. No.: US 2017/0061368 A1
(43) Pub. Date: Mar. 2, 2017

(54) METHOD AND APPARATUS FOR PROCESSING LOGISTICS PATH INFORMATION

(71) Applicant: ALIBABA GROUP HOLDING LIMITED, George Town, KY (US)

(72) Inventor: Wei QIN, Hangzhou (CN)

(21) Appl. No.: 15/256,187

(22) Filed: Sep. 2, 2016

(30) Foreign Application Priority Data
Sep. 2, 2015 (CN) 201510557909.1

(51) Int. Cl. G06Q 10/08

(52) U.S. Cl. CPC G06Q 10/0832

(57) ABSTRACT

A method for processing logistics path information is provided. The method includes pre-storing, by a server, attribute information of a plurality of logistics resources, wherein the attribute information indicates whether each logistics resource provides a cold chain function; identifying, by the server, information from an interaction order upon receiving a transmission instruction for the interaction order; determining, according to the identified information, whether a cold chain service is needed; and selecting a logistics path having a cold chain function to carry out a transmission task if the cold chain service is needed.

### CROSS-REFERENCE TO RELATED APPLICATION

This application is based upon and claims priority to Chinese Patent Application No. 201510557909.1, filed Sep. 2, 2015, the entire contents of which are incorporated herein by reference.

### TECHNICAL FIELD

The present application relates to the field of information processing and, more particularly, to a method and an apparatus for processing logistics path information.

### BACKGROUND

With the development of network technology, logistics becomes an increasingly serious bottleneck in fulfilling an interaction order between a user and a network platform. Some network platforms provide a unified logistics resource management platform that can integrate various logistics resources to form a logistics solution. For example, a first user may order a logistics solution by using a logistics platform, and when a second user acquires an item offered by the first user, according to the logistics solution ordered by the first user, the logistics platform can instruct a logistics service provider to complete subsequent procedures such as distribution and transmission. However, even if the fastest logistics path is selected in the distribution process, the item spoils when the acquirer receives it, severely affecting the user experience.

### SUMMARY

The present disclosure provides a method for processing logistics path information. Consistent with some embodiments, the method includes: pre-storing, by a server, attribute information of a plurality of logistics resources, wherein the attribute information indicates whether each logistics resource provides a cold chain function; identifying, by the server, information from an interaction order upon receiving a transmission instruction for the interaction order; determining, according to the identified information, whether a cold chain service is needed; and selecting a logistics path having a cold chain function to carry out a transmission task if the cold chain service is needed.

Consistent with some embodiments, this disclosure provides a method for providing logistics path information. The method includes: receiving, by a server, an order generating request from a client terminal, wherein the order generating request is generated based on an operation of a user; generating an interaction order and determining a transmission condition of the interaction order; and when the transmission condition of the interaction order is met, sending a transmission request to a logistics management server.

Consistent with some embodiments, this disclosure provides an apparatus for processing logistics path information. The apparatus includes: an attribute storing unit that pre-stores attribute information of a plurality of logistics resources, wherein the attribute information indicates whether each logistics resource provides a cold chain function; an information identifying unit that identifies information from an interaction order upon receiving a transmission instruction for the interaction order; a service determining unit that determines, according to the identified information, whether a cold chain service is needed; and a logistics path determining unit that selects a logistics path having a cold chain function to carry out a transmission task if the cold chain service is needed.

Consistent with some embodiments, this disclosure provides an apparatus for providing logistics path information. The apparatus includes: a receiving unit that receives an order generating request from a client terminal, wherein the order generating request is generated based on an operation of a user; a transmission condition determining unit that generates an interaction order and determines a transmission condition of the interaction order; and a sending unit that sends a transmission request to a logistics management server when the transmission condition of the interaction order is met.

Consistent with some embodiments, this disclosure provides a non-transitory computer readable medium that stores a set of instructions that are executable by at least one processor of a server to cause the server to perform a method for processing logistics path information. The method includes: pre-storing, by the server, attribute information of a plurality of logistics resources, wherein the attribute information indicates whether each logistics resource provides a cold chain function; identifying, by the logistics management server, information from an interaction order upon receiving a transmission instruction for the interaction order; determining, according to the identified information, whether a cold chain service is needed; and selecting a logistics path having a cold chain function to carry out a transmission task if the cold chain service is needed.

Additional objects and advantages of the disclosed embodiments will be set forth in part in the following description, and in part will be apparent from the description, or may be learned by practice of the embodiments. The objects and advantages of the disclosed embodiments may be realized and attained by the elements and combinations set forth in the claims.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flowchart of an exemplary method for processing logistics path information, consistent with some embodiments of this disclosure.

FIG. 2 is a flowchart of an exemplary method for providing logistics path information, consistent with some embodiments of this disclosure.

FIG. 3 is a block diagram of an exemplary apparatus for processing logistics path information, consistent with some embodiments of this disclosure.

FIG. 4 is a block diagram of an exemplary apparatus for providing logistics path information, consistent with some embodiments of this disclosure.

### DESCRIPTION OF THE EMBODIMENTS

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of devices and methods consistent with aspects related to the invention as recited in the appended claims.

Products such as fresh foods generally require a low-temperature or low-humidity environment, and these products are referred to as frozen products. In this disclosure, a supply chain of frozen products is referred to as a cold chain, and a device for producing a low-temperature and low-humidity environment is referred to as a cold chain device. Cold chain devices may include a low-temperature cold storage, a normal-temperature cold storage, a low-temperature refrigerator, a normal-temperature refrigerator, a refrigerator car, a refrigerated container, a vaccine transport vehicle, a spare ice pack, and the like. The term “cold chain logistics” generally refers to the management of operations in which refrigerated or frozen products are constantly in a stipulated low-temperature environment during production, storage and transportation, sales and all links before being consumed, so as to ensure the quality and performance of goods. In an e-business platform, a logistics resource provides a cold chain function if a provider of the logistics resource possesses the required cold chain devices to use. In practice, some logistics resources have the cold chain function, while some other logistics resources do not have the cold chain function.

Different logistics resources may provide different services. For example, some resources can provide only a warehouse service, and some resources can provide only a distribution service. Among resources that provide distribution services, some resources can provide main line distribution (e.g., distribution to municipal distribution centers only), while some resources can provide landing distribution to deliver the goods to the end customer.

To fully utilize various logistics resources, in an integrated logistics resource management platform (such as CAINIAO, which is a logistics platform of ALIBABA GROUP) of an e-business system, multiple logistics resources may be combined to form multiple logistics paths. The logistics resources may be classified according to types of services they can provide, such as a transit warehouse, a main line distribution, or a landing distribution. Then, multiple logistics entities may cooperate with each other to provide a logistics service solution, such as using a transit warehouse in conjunction with a main line distribution and a landing distribution, or using a transit warehouse in conjunction with a landing distribution, and so on. The complete logistics service carrier organized by multiple logistics entities and corresponding logistics resources may be referred to as a logistics path (i.e., logistics route). For example, in the logistics service solution using a transit warehouse in conjunction with a main line distribution and a landing distribution, a logistics path in the system is formed by selecting a first logistics service entity capable of providing a transit warehouse service, a second logistics service entity capable of providing a main line service, and a third logistics service entity capable of providing a landing distribution service. The logistics service entities cooperate with each other on each logistics link of commodity distribution so as to provide logistics services.

In practice, there may be an extremely large number of logistics resources, and an extremely large number, usually hundreds of thousands, of logistics paths may be formed by combining different types of logistics resources that have matching service coverage. Thus, various optional logistics paths may be pre-generated, and a business may order logistics paths that meet its own requirement in different scenarios. Alternatively, the logistics resource management platform may perform the assembly of a logistics path when goods are to be shipped.

During selection of a specific logistics path for an actual interaction order, issues being considered often include whether logistics resources in all links of a route can cover a transit from the dispatching address to the destination address and the required distribution timing condition. For some commodities of a particular category, however, additional issues are to be considered. Consistent with some embodiments of this disclosure, information of whether each logistics resource has a cold chain function may be pre-stored in an e-business system, such that when a logistics path is generated or selected for a frozen product, the commodity can be delivered only when each logistics resource constituting the logistics path has the cold chain function. In this way, commodities of a special category, such as fresh foods, may be preserved during a distribution process.

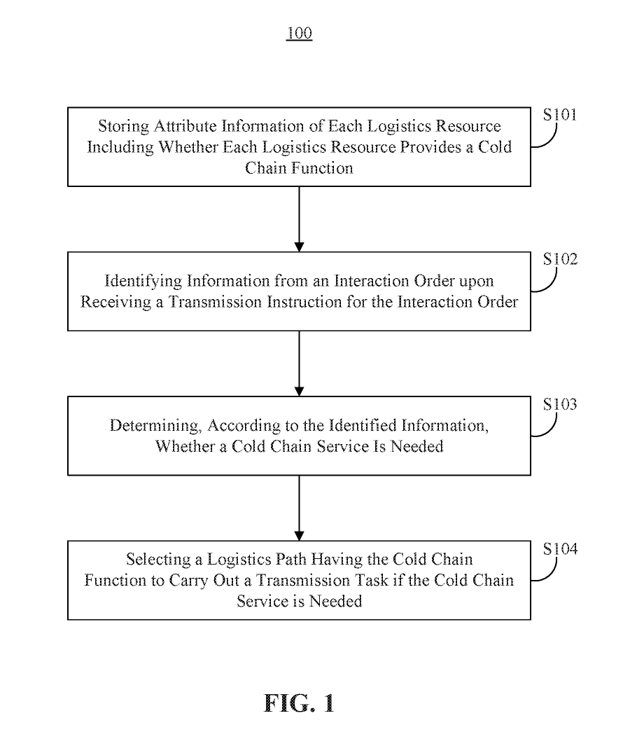

FIG. 1 is a flowchart of an exemplary method 100 for processing logistics path information, consistent with some embodiments of this disclosure. The method 100 may be performed by a server, such as a logistics management server. Referring to FIG. 1, the method 100 includes the following steps.

In step S101, the server stores attribute information of each logistics resource including whether each logistics resource provides a cold chain function. For example, when a logistics service provider cooperates with a logistics management platform of an e-business system, the logistics service provider may submit its attribute information including whether the logistics service provider has a cold chain function. The attribute information may further include a service coverage and a distribution time of the logistics service provider. The attribute information may be stored in a database of the server.

The service coverage may include a collection service coverage and a distribution service coverage. The service coverage information may be stored by the server in two fields: “from” and “to”. For example, assuming a collection area of a transit warehouse may be Beijing, and goods in the transit warehouse can be distributed to distribution centers in Beijing and Hangzhou, then the “from” field is Beijing and the “to” field is Beijing and Hangzhou. As another example, assuming a collection area of a landing distribution service is Hangzhou, and a home transmission service (i.e., a home delivery service) can be provided in Hangzhou and Shanghai, then the “from” field is Hangzhou and the “to” field is Hangzhou and Shanghai. In some embodiments, another field may be set in the database to indicate whether a logistics resource has a cold chain function, and a value of the corresponding field is set to “YES” or “NO” according to the attribute information submitted by the service provider. Table 1 below shows an example of attribute information for various logistic resources stored in the server.

TABLE 1

| Logistics | | | | Whether the logistics |
|---|---|---|---|---|
| resource | Resource | Coverage | Coverage | resource has a cold |
| number | type | from | to | chain function |
| WL001 | Transit | Beijing | Beijing, | Yes |
| | warehouse | | Hangzhou | |
| WL002 | Landing | Hangzhou | Hangzhou, | Yes |
| | distribution | | Shanghai | |
| WL003 | Landing | Hangzhou, | Hangzhou, | No |
| | distribution | Shanghai | Shanghai, | |
| | | | Suzhou | |
| . . . | . . . | . . . | . . . | . . . |

In some embodiments, the server may generate a logistics path when the distribution area of a logistic resource (i.e., “coverage to”) in the current link matches the collection area of a logistic resource (i.e., “coverage from”) in the next link. For example, in Table 1 above, WL001 is a first link and the distribution area (i.e., “coverage to”) is Beijing and Hangzhou, indicating that WL001 can deliver goods to distribution centers in Beijing and Hangzhou. WL002 is a second link connected to WL001, and its collection area (i.e., “coverage from”) is Hangzhou, indicating that WL002 can collect goods from Hangzhou and provide a home transmission service in a certain area. Thus, WL001 and WL002 can be combined to form a logistics path. That is, after WL001 distributes goods to Hangzhou, WL002 can collect the goods from Hangzhou and carry out a subsequent home transmission service. Similarly, collection area (i.e., “coverage from”) of WL003 also includes Hangzhou, and thus, WL001 and WL003 can also be combined to form a logistics path. In some embodiments, the server may provide all possible logistics paths formed by various combinations of logistics resources for a business user to choose from. Table 2 below shows examples of logistics paths stored in the server.

TABLE 2

| | First | | Second | |
|---|---|---|---|---|
| Logistics | logistics | Type of first | logistics | Type of second |
| path | resource | logistics resource | resource | logistics resource |
| Route 1 | WL001 | Transit warehouse | WL002 | Landing distribution |
| Route 2 | WL001 | Transit warehouse | WL003 | Landing distribution |
| . . . | | . . . | . . . | . . . |

In step S102, the server identifies information from an interaction order (i.e., transaction order) upon receiving a transmission instruction (i.e., delivery instructions) for the interaction order. After a user purchases an object (i.e., commodity object) of a specific business, a corresponding interaction order may be generated, and after that, transmission for the interaction order may be triggered. For example, for some particular services, an automatic transmission indicator may be provided, such that when receiving a notification indicating that payment for the interaction order is successful, a transaction server (e.g., a front-end transaction server) may instruct the server to arrange transmission (i.e., delivery).

In some embodiments, the server may obtain identification information of an object from the interaction order and may determine, according to a category to which the object belongs, whether a cold chain service needs to be used for the transmission. For example, if it is determined that the object belongs to a fresh food category, the server may determine that the cold chain service needs to be used.

In some embodiments, when generating an order, the transaction server may add a special label to the interaction order for an object that belongs to a particular category. For example, if a user purchases an object of a fresh food category, such as an object on the website “miao.tmall.com,” the transaction server may add a “fresh food order” label when generating the interaction order. After receiving an instruction of arranging transmission for the interaction order, the server may identify the label from the interaction order and determine, according to the label, whether to use the cold chain service.

In step S103, the server determines, according to the identified information, whether a cold chain service is needed. For example, a list of categories that need the cold chain service may be pre-established in the server, where the list may include a fresh food category, a fruit category, and the like. When identification information of an object is identified in step S102, the server may determine a category to which the object belongs and whether the category appears in the pre-established category list. If the category appears in the category list, it can be determined that the object needs the cold chain service. If the category does not appear in the category list, it can be determined that the object does not need the cold chain service, and accordingly, the object can be delivered and distributed by selecting a normal-temperature route in a regular manner. When a particular label added by the transaction server to the interaction order is identified in step S102, the server may determine whether the cold chain service is needed according to the label.

In step S104, if the cold chain service is needed, the server selects a logistics path having the cold chain function to carry out a transmission task. In this step, each logistics resource on the selected logistics path may have the cold chain function. For example, if a user, such as a seller or a business, does not pre-order any logistics path, the server may first create a logistics path, and then determine whether each logistics resource on the route has the cold chain function. If each logistics resource on the route has the cold chain function, the route can be selected as the logistics path.

To create a logistics path, the server may pre-store service coverage information of each logistics resource, for example, as the coverage information shown in Table 1. When identifying information from an interaction order, address information may also be identified, such as a ship-from address (e.g., the origin address) and a ship-to address (e.g., the destination address). In this way, during logistics path creation, at least one logistics path can be created according to the address information and the service coverage information of each logistics resource, where each logistics path includes one or more logistics resources. For example, assuming a ship-from address of an interaction order is Hangzhou and a ship-to address is Beijing, if a logistics path is created by combining a transit warehouse and a landing distribution, all transit warehouse providers whose collection coverage include Beijing and all landing distribution providers whose distribution coverage include Hangzhou may be identified. Then a matching operation may be performed on the distribution coverage of these transit warehouse providers and collection coverage of these landing distribution providers. If a distribution coverage of a transit warehouse provider successfully matches a collection coverage of a landing distribution provider, the transit warehouse provider and the landing distribution provider can be combined in a logistics path.

In some embodiments, a user (such as a seller or business in a transaction platform) may order one or more logistics paths according to a category of its commodities. In some logistics paths, each logistics resource may have the cold chain function, while in some other logistics paths, only some of logistics resources have the cold chain function, or even none of logistics resources have the cold chain function. The server may pre-store logistics paths that are associated with each user. For example, the logistics paths may be associated with a user based on user orders, preset configurations by the user, existing contracts with the user, and so on. If it is determined that an interaction order needs the cold chain service, the server can determine, according to the pre-stored information, logistics paths associated with the user. Then for each logistics path, the server may determine whether each logistics resource included in the logistics path has the cold chain function, and select a logistics path for the transmission task according to the determination result.

In some embodiments, the logistics paths associated with the user may be filtered first according to address information associated with the interaction order, and then a determination about the cold chain function may be made. The address information may include information about a ship-from address and a ship-to address. The ship-from address may be preconfigured by a user, such as a seller or a business, and the ship-to address may be set by another user, such as a buyer, when submitting an interaction order. Thus, the server may identify the information about the ship-from address and the ship-to address from the interaction order and select, according to the stored coverage information of the logistics resources, a set of logistics paths that meet the requirement for service coverage.

For example, assuming in an interaction order, the ship-from address is Beijing and the ship-to address is Shanghai, logistics paths associated with the user include a logistics path 1 consisting of logistics resources WL001 and WL002 and a logistics path 2 consisting of WL001 and WL003 in Table 2 above. The server may determine, based on the stored attribute information of the logistics resources in Table 1, that the collection coverage of WL001 includes Beijing, both the distribution area of WL002 and distribution area of WL003 include Shanghai, and both logistics path 1 and logistics path 2 meet the requirement for service coverage.

The server may then determine whether the logistics resources included in logistics path 1 and logistics path 2 have the cold chain function. For example, as shown in Table 1, both WL001 and WL002 have the cold chain function while WL003 does not have the cold chain function. Accordingly, only logistics path 1 meets the cold chain requirement, and logistics path 2 does not meet the cold chain requirement.

After selecting the logistics path, the server may send instructions to the corresponding logistic resources. For example, the server may send an instruction to WL001 to collect specified goods from a specified warehouse and deliver the goods to Hangzhou. After the goods arrive at Hangzhou, the server may instruct WL002 to collect the goods from a distribution center in Hangzhou, and distribute the goods to a specific ship-to address. In this process, since both WL001 and WL002 have the cold chain function, goods of a special category can be prevented from spoiling during transmission or distribution.

In some embodiments, there may be multiple logistics paths meeting the coverage and cold chain functions requirements, and the server may consider the distribution timing condition in selecting a logistics path. For example, among the logistics paths meeting the coverage and cold chain functions requirements, a logistics path meeting a preset condition for distribution time (for example, being fastest) may be selected as the logistics path for the transmission task. Distribution time of each logistics path may be predetermined and stored in the server. For example, some logistics paths may support arrival on the next day, some others may support arrival in two days, and some may not support a specific distribution time.

In some implementations, a logistics resource having the cold chain function may also support normal-temperature distribution, and may still carry out normal-temperature distribution. In some embodiments, after determining that the cold chain service is needed and determining the logistics path for the transmission task, when sending a distribution instruction to each logistics resource on the logistics path, the server may add to the instruction an indication of using a cold chain device, such that the corresponding logistics resource can carry out cold-chain distribution according to the indication.

In practice, the number of logistics paths for which logistics resource in each process has the cold chain function may be limited. In some embodiments, if an object does not need the cold chain service, the server may select, from the logistics paths associated with the user, logistics paths including at least one logistics resource that does not have the cold chain function, so as to prevent these few routes from being occupied by goods that do not need the cold chain service. The server may then select a logistics path meeting the requirements for service coverage and distribution time, and use the selected logistics path for carrying out the transmission task. In doing so, the cold chain route can be dedicated to providing services for goods of a special category, thereby further ensuring the logistics service quality for objects of the special category.

In the method 100, by selecting a logistics path having the cold chain function to carry out the transmission task, a cold chain service can be provided for objects of a special category during transmission and distribution, so as to prevent goods from going bad during transportation, reduce the ratio of exchange or refunding, and save system resources.

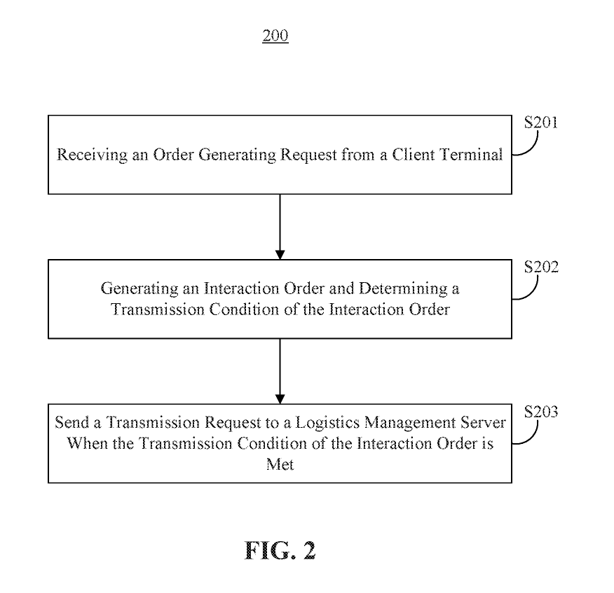

FIG. 2 is a flowchart of an exemplary method 200 for providing logistics path information, consistent with some embodiments of this disclosure. The method 200 may be performed by a server, such as a transaction server configured to interact with a front-end user, generate an interaction order, and the like. Referring to FIG. 2, the method 200 includes the following steps.

In step S201, the server receives an order generating request from a client terminal, where the order generating request is generated based on an operation of a user.

In step S202, the server generates an interaction order and determines a transmission condition of the interaction order.

In some embodiments, the server may determine, according to a service type associated with the interaction order, whether automatic transmission is needed. If automatic transmission is needed, after receiving a payment success notification message corresponding to the interaction order, the server may determine that the transmission condition of the interaction order is met.

In some embodiments, when an interaction order is generated, the server may determine, according to a category to which a corresponding object belongs, whether a cold chain service needs to be carried out. If the cold chain service needs to be carried out, the server may add a preset label to the interaction order indicating to a logistics management server that the cold chain service needs to be carried out.

In step S203, when the transmission condition of the interaction order is met, the server sends a transmission request to a logistics management server. The logistics management server may identify related information from the interaction order, determine whether a cold chain service is needed based on the identified information, and if the cold chain service is needed, select a logistics path having a cold chain function to carry out a transmission based on pre-stored attribute information of each logistics resource, where each logistics resource included in the selected logistics path has the cold chain function.

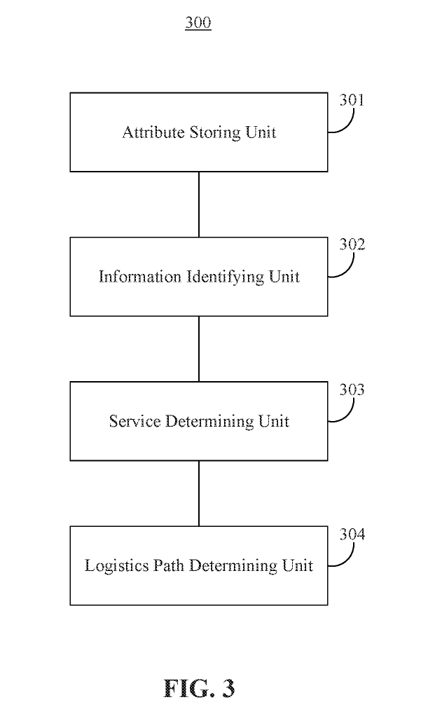

FIG. 3 is a block diagram of an exemplary apparatus 300 for processing logistics path information, consistent with some embodiments of this disclosure. The apparatus 300 may be implemented as a part or all of a server, such as a logistics management server. Referring to FIG. 3, the apparatus 300 includes an attribute storing unit 301, an information identifying unit 302, a service determining unit 303, and a logistics path determining unit 304.

The attribute storing unit 301 is configured to pre-store attribute information of each logistics resource including whether each logistics resource provides a cold chain function. In some embodiments, the pre-stored attribute information of the logistics resources further includes service coverage information of each logistics resource.

The information identifying unit 302 is configured to identify information from the interaction order when a transmission instruction for an interaction order is received. The information identified from the interaction order may include identification information of an object and address information associated with the interaction order. In some embodiments, the information identified from the interaction order may include a label of the interaction order added by a transaction server when generating the interaction order, indicating whether a cold chain service is needed.

The service determining unit 303 is configured to determine, according to the identified information, whether a cold chain service is needed. The service determining unit may further be configured to determine, according to a category to which the object belongs, whether the cold chain service is needed. In some embodiments, the service determining unit may further be configured to determine, according to whether the interaction order has a preset label, whether the cold chain service is needed.

The logistics path determining unit 304 is configured to select a logistics path having the cold chain function to carry out a transmission task if the cold chain service is needed. Each logistics resource included in the logistics path may have the cold chain function.

In some embodiments, the logistics path determining unit 304 further includes a route generating sub-unit, a first determining sub-unit, and a second determining sub-unit (not shown). The route generating sub-unit is configured to generate one or more logistics paths according to the address information and the service coverage information of each logistics resource, where each logistics path includes one or more logistics resources. The first determining sub-unit is configured to determine, for each generated logistics path, whether each logistics resource included in the logistics path has the cold chain function. The second determining sub-unit is configured to determine the logistics path for the transmission task according to a determination result of the first determining sub-unit.

In some embodiments, the attribute storing unit 301 is further configured to pre-store logistics path information associated with each user (such as a seller or a business), and the pre-stored attribute information of the logistics resources further includes service coverage information of each logistics resource. The information identifying unit 302 is further configured to identify information about the user and address information from the interaction order. The logistics path determining unit 304 may include a coverage determining sub-unit, a cold chain function determining sub-unit, and a logistics path selecting sub-unit. The coverage determining sub-unit is configured to select, from the logistics paths associated with the user, a first set of logistics paths meeting a service coverage requirement according to the address information and the service coverage information of each logistics resource. The cold chain function determining sub-unit is configured to determine, for each logistics path in the first set of logistics paths, whether each logistics resource included in the logistics path has the cold chain function. The logistics path selecting sub-unit is configured to determine the logistics path for the transmission task according to the determination result of the cold chain function determining sub-unit. In some embodiments, the pre-stored attribute information of the logistics resources further includes distribution timing information of each logistics resource. The logistics path selecting sub-unit may further include a set generating sub-unit and a timing determining sub-unit. The set generating sub-unit is configured to, for each of the first set of logistics paths, if the cold chain function determining sub-unit determines that each of the corresponding logistics resources provides the cold chain function, add the logistics path in a second set of logistics paths. The timing determining sub-unit is configured to select, based on the distribution timing information of the logistics resources and a preset distribution timing condition, the logistics path having the cold chain function to carry out the transmission task from the second set of logistics paths.

In some embodiments, the apparatus 300 may further include an indication unit configured to include, in a distribution instruction, an indication of using a cold chain device when the distribution instruction is sent to each logistics resource in the logistics path for transmission.

In some embodiments, the apparatus 300 may further include a logistics path selecting unit configured to select a logistics path which includes at least one logistics resource not having the cold chain function to carry out the transmission task, if the object does not need the cold chain service.

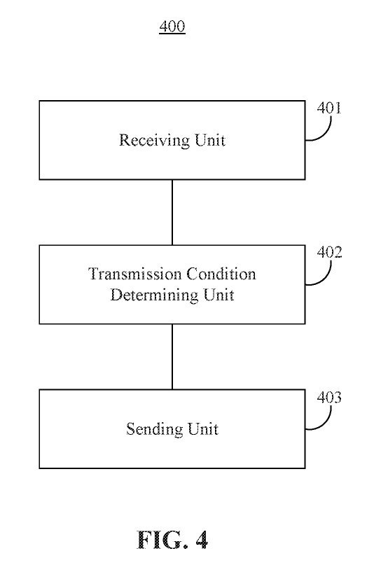

FIG. 4 is a block diagram of another exemplary apparatus 400 for providing logistics path information, consistent with some embodiments of this disclosure. The apparatus 400 may be implemented as a part or all of a server, such as a transaction server. Referring to FIG. 4, the apparatus 400 includes a receiving unit 401, a transmission condition determining unit 402, and a sending unit 403.

The receiving unit 401 is configured to receive an order generating request from a client terminal, where the order generating request is generated based on an operation of a user.

The transmission condition determining unit 402 is configured to generate an interaction order and determine a transmission condition of the interaction order.

The sending unit 403 is configured to, when the transmission condition of the interaction order is met, send a transmission request to a logistics management server. The logistics management server may identify related information from the interaction order, determine whether a cold chain service is needed based on the identified information, and if the cold chain service is needed, select a logistics path having a cold chain function to carry out a transmission based on pre-stored attribute information of each logistics resource, where each logistics resource included in the selected logistics path has the cold chain function.

In some embodiments, the apparatus 400 may further include a service determining unit and a label generating unit (not shown). The service determining unit is configured to determine, according to a category to which a corresponding object belongs, whether the cold chain service needs to be performed when the interaction order is generated. The label generating unit is configured to add a preset label to the interaction order if the cold chain service needs to be performed. The logistics management server may then determine, according to the label, whether the cold chain service needs to be performed.

In exemplary embodiments, there is also provided a non-transitory computer-readable storage medium including instructions executable by a processor in a server for performing the above-described methods For example, the non-transitory computer-readable storage medium may be a ROM, a RAM, a CD-ROM, a magnetic tape, a flash memory, a cache, a register, a floppy disc, an optical data storage device, and the like.

One of ordinary skill in the art will understand that the above described embodiments can be implemented by hardware, software, or a combination of hardware and software. If implemented by software, it may be stored in the above-described computer-readable medium. The software, when executed by the processor can perform the disclosed methods. The computing units and the other functional units described in this disclosure can be implemented by hardware, or software, or a combination of hardware and software for allowing a specialized device to perform the functions described above. One of ordinary skill in the art will also understand that multiple ones of the above described units may be combined as one unit, and each of the above described units may be further divided into a plurality of sub-units.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes may be made without departing from the scope thereof. It is intended that the scope of the invention should only be limited by the appended claims.

What is claimed is:

1. A method for processing logistics path information, comprising:
pre-storing, by a server, attribute information of a plurality of logistics resources, wherein the attribute information indicates whether each logistics resource provides a cold chain function;
identifying, by the server, information from an interaction order upon receiving a transmission instruction for the interaction order;
determining, according to the identified information, whether a cold chain service is needed; and
selecting a logistics path having a cold chain function to carry out a transmission task if the cold chain service is needed.

2. The method of claim 1, wherein the identified information includes identification information of an object, and wherein determining whether the cold chain service is needed comprises:
determining, according to a category to which the object belongs, whether the cold chain service is needed.

3. The method of claim 1, wherein identifying information from the interaction order comprises:
identifying whether the interaction order includes a preset label added by a transaction server when generating the interaction order; and
wherein determining whether a cold chain service is needed comprises:
determining, according to whether the interaction order includes the preset label, whether the cold chain service is needed.

4. The method of claim 1, wherein the pre-stored attribute information includes service coverage information of the logistics resources, and identified information includes address information associated with the interaction order, and wherein selecting the logistics path having the cold chain function comprises:
generating one or more logistics paths according to the address information and the service coverage information of the plurality of logistics resources, wherein each of the one or more logistics paths includes one or more logistics resources;
determining, for each of the one or more logistics paths, whether each of the one or more logistics resources provides the cold chain function; and
selecting the logistics path having the cold chain function to carry out the transmission task according to a determination result.

5. The method of claim 1, wherein the server further pre-stores a plurality of logistics paths associated with a user, the pre-stored attribute information includes service coverage information of the logistics resources, and the identified information includes information about the user and address information associated with the interaction order, and wherein selecting the logistics path having the cold chain function comprises:
selecting, from the plurality of logistics paths associated with the user, a first set of logistics paths according to the address information and the service coverage information of each logistics resource, each of the first set of logistics paths meeting a service coverage requirement and including one or more logistics resources;
determining, for each of the first set of logistics paths, whether each of the one or more logistics resources provides the cold chain function; and
selecting the logistics path having the cold chain function to carry out the transmission task according to a determination result.

6. The method of claim 5, wherein the pre-stored attribute information further includes distribution timing information of the logistics resources, and wherein selecting the logistics path having the cold chain function further comprises:
for each of the first set of logistics paths, if the determination result indicates that each of the corresponding logistics resources provides the cold chain function, adding the logistics path in a second set of logistics paths; and
selecting, based on the distribution timing information of the logistics resources and a preset distribution timing condition, the logistics path having the cold chain function to carry out the transmission task from the second set of logistics paths.

7. The method of claim 1, further comprising:
sending a distribution instruction to each logistics resource included in the logistics path, wherein the distribution instruction includes an indication of using a cold chain device.

8. The method of claim 1, further comprising:
if it is determined that the cold chain service is not needed, selecting a logistics path that includes at least one logistics resources not having the cold chain function to carry out the transmission task.

9. A method for providing logistics path information, comprising:
receiving, by a server, an order generating request from a client terminal, wherein the order generating request is generated based on an operation of a user;
generating an interaction order and determining a transmission condition of the interaction order; and
when the transmission condition of the interaction order is met, sending a transmission request to a logistics management server.

10. The method of claim 9, further comprising:
determining, by the server and according to a category to which an object belongs, whether the cold chain service needs to be performed; and
if the cold chain service needs to be performed, adding a preset label to the interaction order.

11. An apparatus for processing logistics path information, comprising:
an attribute storing unit that pre-stores attribute information of a plurality of logistics resources, wherein the attribute information indicates whether each logistics resource provides a cold chain function;
an information identifying unit that identifies information from a interaction order upon receiving a transmission instruction for the interaction order;
a service determining unit that determines, according to the identified information, whether a cold chain service is needed; and
a logistics path determining unit that selects a logistics path having a cold chain function to carry out a transmission task if the cold chain service is needed.

12. The apparatus of claim 11, wherein the identified information includes identification information of an object, and wherein the service determining unit is further configured to:
determine, according to a category to which the object belongs, whether the cold chain service is needed.

13. The apparatus of claim 11, wherein the information identifying unit is further configured to:
identify whether the interaction order includes a preset label added by a transaction server when generating the interaction order; and
wherein the service determining unit is further configured to:
determine, according to whether the interaction order includes the preset label, whether the cold chain service is needed.

14. The apparatus of claim 11, wherein the pre-stored attribute information includes service coverage information of the logistics resources, and identified information includes address information associated with the interaction order, and wherein the logistics path determining unit comprises:
a route generating sub-unit that generates one or more logistics paths according to the address information and the service coverage information of the plurality of logistics resources, wherein each of the one or more logistics paths includes one or more logistics resources;
a first determining sub-unit that determines, for each of the one or more logistics paths, whether each of the one or more logistics resources provides the cold chain function; and
a second determining sub-unit that selects the logistics path having the cold chain function to carry out the transmission task according to a determination result.

15. The apparatus of claim 11, wherein the pre-stored attribute information includes service coverage information of the logistics resources, the attribute storing unit is further configured to pre-store a plurality of logistics paths associated with a user, and the identified information includes information about the user and address information associated with the interaction order, and wherein the logistics path determining unit comprises:
a coverage determining sub-unit that selects, from the plurality of logistics paths associated with the user, a first set of logistics paths according to the address information and the service coverage information of each logistics resource, each of the first set of logistics paths meeting a service coverage requirement and including one or more logistics resources;
a cold chain function determining sub-unit that determines, for each of the first set of logistics paths, whether each of the one or more logistics resources provides the cold chain function; and
a logistics path selecting sub-unit that selects the logistics path having the cold chain function to carry out the transmission task according to a determination result of the cold chain function determining sub-unit.

16. The apparatus of claim 15, wherein the pre-stored attribute information further includes distribution timing information of the logistics resources, and wherein logistics path selecting sub-unit comprises:
a set generating sub-unit that, for each of the first set of logistics paths, adds the logistics path in a second set of logistics paths if the cold chain function determining sub-unit determines that each of the corresponding logistics resources provides the cold chain function; and
a timing determining sub-unit that selects, based on the distribution timing information of the logistics resources and a preset distribution timing condition, the logistics path having the cold chain function to carry out the transmission task from the second set of logistics paths.

17. The apparatus of claim 11, further comprising an indication unit configured to:
include, in a distribution instruction, an indication of using a cold chain device when the distribution instruction is sent to each logistics resource included in the logistics path.

18. The apparatus of claim 11, further comprising a logistics path selecting unit configured to:
if the service determining unit determines that the cold chain service is not needed, select a logistics path that includes at least one logistics resources not having the cold chain function to carry out the transmission task.

19. An apparatus for providing logistics path information, comprising:
a receiving unit that receives an order generating request from a client terminal, wherein the order generating request is generated based on an operation of a user;
a transmission condition determining unit that generates an interaction order and determines a transmission condition of the interaction order; and
a sending unit that sends a transmission request to a logistics management server when the transmission condition of the interaction order is met.

20. The apparatus of claim 19, further comprising:
a service determining unit that determines, according to a category to which an object belongs, whether the cold chain service needs to be performed; and
a label generating unit that adds a preset label to the interaction order if the service determining unit determines that the cold chain service needs to be performed.

21. A non-transitory computer readable medium that stores a set of instructions that is executable by at least one processor of a server to cause the server to perform a method for processing logistics path information, the method comprising:
pre-storing, by the server, attribute information of a plurality of logistics resources, wherein the attribute information indicates whether each logistics resource provides a cold chain function;
identifying, by the logistics management server, information from an interaction order upon receiving a transmission instruction for the interaction order;
determining, according to the identified information, whether a cold chain service is needed; and
selecting a logistics path having a cold chain function to carry out a transmission task if the cold chain service is needed.

22. The non-transitory computer readable medium of claim 21, wherein the identified information includes identification information of an object, and wherein the set of instructions that is executable by the at least one processor of the server to cause the server to further perform:
determining, according to a category to which the object belongs, whether the cold chain service is needed.

23. The non-transitory computer readable medium of claim 21, wherein the set of instructions that is executable by the at least one processor of the server to cause the server to further perform:
identifying whether the interaction order includes a preset label added by a transaction server when generating the interaction order; and
determining, according to whether the interaction order includes the preset label, whether the cold chain service is needed.

24. The non-transitory computer readable medium of claim 21, wherein the pre-stored attribute information includes service coverage information of the logistics resources, and identified information includes address information associated with the interaction order, and wherein the set of instructions that is executable by the at least one processor of the server to cause the server to further perform:
generating one or more logistics paths according to the address information and the service coverage information of the plurality of logistics resources, wherein each of the one or more logistics paths includes one or more logistics resources;
determining, for each of the one or more logistics paths, whether each of the one or more logistics resources provides the cold chain function; and
selecting the logistics path having the cold chain function to carry out the transmission task according to a determination result.

25. The non-transitory computer readable medium of claim 21, wherein the server further pre-stores a plurality of logistics paths associated with a user, the pre-stored attribute information includes service coverage information of the logistics resources, and the identified information includes information about the user and address information associated with the interaction order, and wherein the set of instructions that is executable by the at least one processor of the server to cause the server to further perform:
selecting, from the plurality of logistics paths associated with the user, a first set of logistics paths according to the address information and the service coverage information of each logistics resource, each of the first set of logistics paths meeting a service coverage requirement and including one or more logistics resources;
determining, for each of the first set of logistics paths, whether each of the one or more logistics resources provides the cold chain function; and
selecting the logistics path having the cold chain function to carry out the transmission task according to a determination result.

26. The non-transitory computer readable medium of claim 25, wherein the pre-stored attribute information further includes distribution timing information of the logistics resources, and wherein the set of instructions that is executable by the at least one processor of the server to cause the server to further perform:
for each of the first set of logistics paths, if the determination result indicates that each of the corresponding logistics resources provides the cold chain function, adding the logistics path in a second set of logistics paths; and
selecting, based on the distribution timing information of the logistics resources and a preset distribution timing condition, the logistics path having the cold chain function to carry out the transmission task from the second set of logistics paths.

27. The non-transitory computer readable medium of claim 21, wherein the set of instructions that is executable by the at least one processor of the server to cause the server to further perform:
sending a distribution instruction to each logistics resource included in the logistics path, wherein the distribution instruction includes an indication of using a cold chain device.

28. The non-transitory computer readable medium of claim 21, the set of instructions that is executable by the at least one processor of the server to cause the server to further perform:
if it is determined that the cold chain service is not needed, selecting a logistics path that includes at least one logistics resources not having the cold chain function to carry out the transmission task.

29. A non-transitory computer readable medium that stores a set of instructions that is executable by at least one processor of a server to cause the server to perform a method for processing logistics path information, the method comprising:
receiving an order generating request from a client terminal, wherein the order generating request is generated based on an operation of a user;
generating an interaction order and determining a transmission condition of the interaction order; and
after the transmission condition of the interaction order is met, sending a transmission request to a logistics management server.

30. The non-transitory computer readable medium of claim 29, wherein the set of instructions that is executable by the at least one processor of the server to cause the server to further perform:
determining, by the server and according to a category to which an object belongs, whether the cold chain service needs to be performed; and
if the cold chain service needs to be performed, adding a preset label to the interaction order.
